(19) United States
(12) Patent Application Publication
(10) Pub. No.: US 2026/0202863 A1
(43) Pub. Date: Jul. 16, 2026

(54) Thermostatic assembly, in particular a thermostatic cartridge

(71) Applicant: VERNET, OLLAINVILLE (FR)

(72) Inventors: Evelyne Ming-Ying LAM, Les Clayes-sous-Bois (FR); Gaél Serge MILLET, Arpajon (FR)

(21) Appl. No.: 19/136,934

(22) PCT Filed: Dec. 14, 2023
(86) PCT No.: PCT/EP2023/085855

§ 371 Date: Jun. 9, 2025

(30) Foreign Application Priority Data
Dec. 15, 2022 (FR) FR2213464

(51) Int. Cl. G05D 11/16

(52) U.S. Cl. CPC G05D 11/16

(57) ABSTRACT

This thermostatic assembly includes a casing wherein a mixing chamber, a hot fluid inlet, a cold fluid inlet, and a mixed fluid outlet are defined. In the chamber, a slide-valve for regulating the temperature of the mixed fluid is movable along an axis of the chamber to block, in respective inverse proportions, a hot fluid passage and a cold fluid passage. A thermostatic element comprises a body, arranged in the chamber to be in contact with the mixed fluid and to be connected in movement to the slide-valve, and a piston, connected to the casing being centered on the axis. The piston is received in the body in a manner movable under the action of a thermodilatable material of the body, being axially slidably mounted in a guide of the body, from which the piston emerges outside the body.

The present invention relates to a thermostatic assembly, in particular a thermostatic cartridge.

To regulate the temperature of a mixture of a hot fluid and a cold fluid, particularly a mixture of hot water and cold water in a sanitary installation, it is known to use a thermostatic element and a valve, which are arranged in a hollow outer casing, typically a cartridge body to be fitted into a faucet body. The thermostatic element comprises a piston, which is normally fixed relative to the casing, and a body, which contains a thermodilatable material and relative to which the piston is translatable along an axis under the action of the thermodilatable material during the expansion thereof. The body includes a guide, from which the piston emerges outside the body and wherein the piston is slidably mounted along the axis. The valve is connected to the body so as to be driven in movement along the axis inside a chamber of the casing to be able to block, in respective inverse proportions, a first passage, which is axially delimited between the valve and the casing and which is supplied with hot fluid coming from a hot fluid inlet delimited by the casing, and a second passage, which is axially delimited between the valve and the casing and which is supplied with cold fluid coming from a cold fluid inlet delimited by the casing. The hot fluid and the cold fluid that the valve allows to pass through these two passages to reach the chamber mix in the latter and form, downstream of the valve, a mixed fluid that exits the casing by flowing along the body of the thermostatic element to thermally act on the thermodilatable material. By modifying the position of the piston relative to the casing, generally by means of an ad hoc control mechanism, the thermostatic regulation temperature can be set, i.e., the balancing temperature around which the temperature of the mixed fluid is regulated. An example of this type of cartridge is provided by FR 2 921 709.

The sliding mounting of the piston in the guide of the thermostatic element body needs to be sealed to prevent the hot, cold, and/or mixed fluids from entering the body and/or to prevent lubricants provided in the sliding mounting from escaping outside the thermostatic element. To this end, the thermostatic element generally includes a sealing bellows, which surrounds the sliding mounting and the opposite ends of which along the axis are respectively fixedly secured to the body and the piston. Document FR 3 109 828 discloses such a sealing bellows. In practice, such a sealing bellows is satisfactory but takes up substantial space inside the aforementioned casing, partially occupying the chamber, which can hinder the flow of fluids in the chamber and limit the maximum flow rate, and which may also require reinforcing the securing of the bellows to the piston to withstand fluid flows in the chamber. The assembly between the body of the thermostatic element and the valve is also complicated, in the sense that it is generally necessary to temporarily remove the bellows to allow this assembly to be made, before repositioning the bellows once the valve is connected to the body.

The aim of the present invention is to propose a new thermostatic assembly the sliding mounting of the piston thereof in the guide of the thermostatic element body is sealed in an improved, particularly less constraining manner.

To this end, the invention relates to a thermostatic assembly, such as defined in claim 1.

One of the ideas underlying the invention is to replace the aforementioned sealing bellows with a sealing sleeve, which is coaxially fitted around the guide in a fixed manner along the axis and which is coaxially fitted around the piston not in a fixed manner but in sliding contact along the axis with the piston. This sealing sleeve is thus applied in a scraping manner against the piston all around the axis, which ensures the sealing of the contact between said sleeve and the piston, including during axial movements of the piston relative to the body. The sealing sleeve is advantageously flexible, in particular presenting an elastic resilience that is utilized to ensure a substantially radial application of the sealing sleeve against the piston. In all cases, the sealing sleeve presents the advantage of being able to be dimensioned along the axis in a particularly reduced manner, in particular compared to the aforementioned sealing bellows: due to this axial compactness of the sealing sleeve, the flow of fluids in the chamber is less, or not at all, disturbed around the piston, which does not alter the performance of the thermostatic assembly according to the invention in terms of maximum admissible flow rate. The assembly between the body of the thermostatic element and the slide-valve is advantageously facilitated by the sealing sleeve, in the sense that the latter can be dimensioned compactly enough to, while remaining in place on the body and vis-à-vis the movable piston, not interfering with the slide-valve during this assembly, as explained in more detail hereinbelow. More generally, the sealing sleeve of the thermostatic assembly according to the invention allows for improved performance of this thermostatic assembly, in connection with, among other things, the assembly thereof, the thermostatic regulation capabilities thereof, the cost thereof, etc., also as detailed below.

Further advantageous characteristics of the thermostatic assembly according to the invention are specified in other claims.

The invention will be better understood by reading the following description, given solely by way of example and referring to the drawings on which:

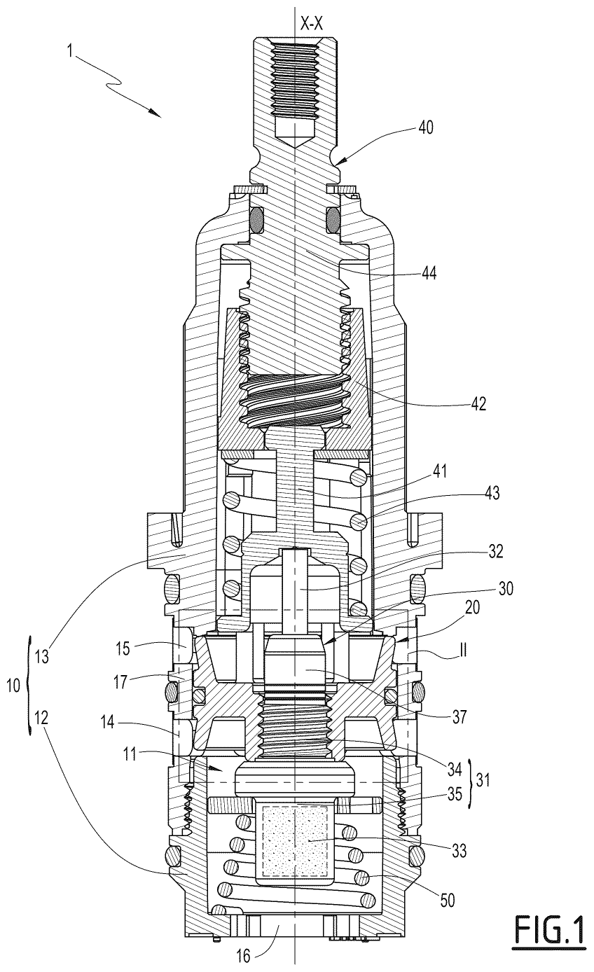

FIG. 1 is a longitudinal section of a thermostatic assembly according to the invention, made in the form of a thermostatic cartridge;

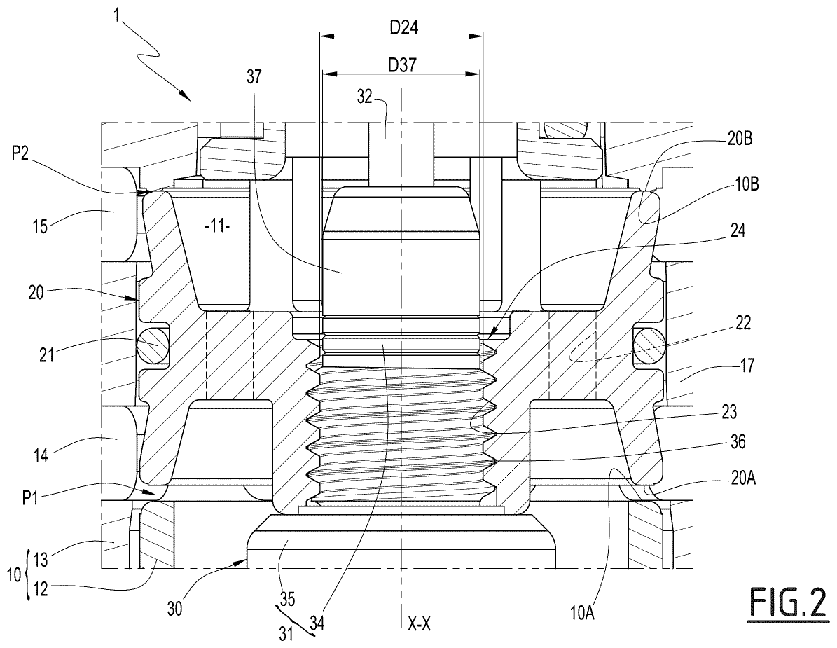

FIG. 2 is a larger scale view of the detail framed Il in FIG. 1;

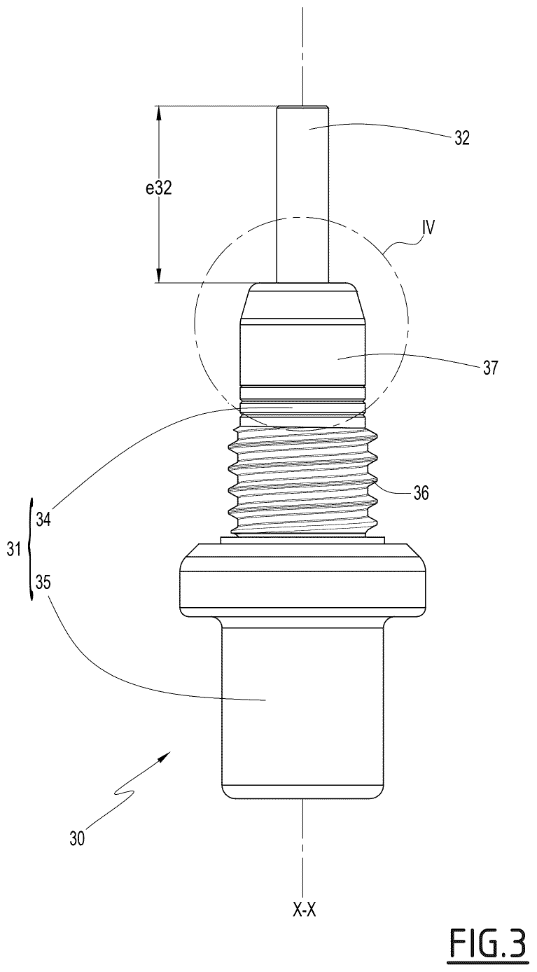

FIG. 3 is an elevation view of a thermostatic element belonging to the thermostatic assembly of FIGS. 1 and 2, shown alone; and

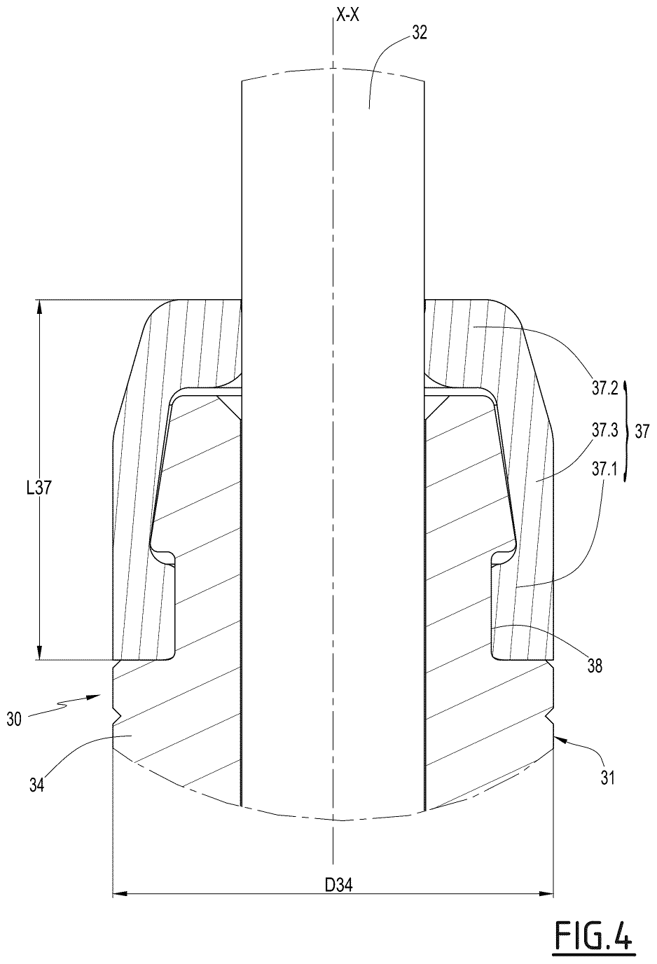

FIG. 4 is a longitudinal section of the detail circled IV in FIG. 3.

FIGS. 1 and 2 show a thermostatic cartridge 1 arranged around and along an axis X-X. This thermostatic cartridge 1 is suitable for equipping a mixing faucet to be supplied with hot and cold water, not shown as such in the figures, or, more generally, for equipping an installation supplied with a hot fluid and a cold fluid to be mixed.

The thermostatic cartridge 1 includes, as the main external component, a hollow casing 10. This casing 10 is intended to be mounted sealed in a body of the aforementioned mixing faucet.

The casing 10 internally defines a cylindrical chamber 11 centered on the axis X-X. The hot and cold water to be regulated by the thermostatic cartridge 1 are intended to mix inside the chamber 11, forming a mixed water.

For convenience, the rest of the description is oriented with respect to the axis X-X, in the sense that the terms “upper” and “top” correspond to an axial orientation turned towards the upper part of FIGS. 1 to 4, while the terms “lower” and “bottom” correspond to an axial direction of opposite sense.

In the embodiment considered in the figures, and as clearly visible in FIGS. 1 and 2, the casing 10 includes two distinct housings, namely a lower housing 12 and an upper housing 13, which are fixedly secured to each other. The chamber 11 is jointly delimited by the lower housing 12 and the upper housing 13, being formed by an internal volume of the upper housing 13 inside which the lower housing 12 is arranged in a sealed manner without the latter occupying the aforementioned internal volume in its entirety. The embodiment of the casing 10, here associating the lower housing 12 and the upper housing 13, is not limiting.

Whatever the embodiment thereof, the casing 10 has a hot water inlet 14, a cold water inlet 15, and a mixed water outlet 16, which each connect, distinctly from one another, the outside of the casing 10 to the chamber 11. The outlet of the hot water inlet 14 into the chamber 11 and the outlet of the cold water inlet 15 into the chamber 11 are axially offset from each other, being separated from each other by a lateral wall 17 of the chamber 11, centered on the axis X-X. The embodiment of the hot water inlet 14, the cold water inlet 15, and the mixed water outlet 16 is not limiting as long as the hot water inlet 14 constitutes an entry through which the hot water enters the chamber 11 from outside the casing 10, the cold water inlet 15 constitutes an entry through which the cold water enters the chamber 11 from outside the casing 10, and the mixed water outlet 16 constitutes an exit through which the mixed water contained in the chamber 11 exits the casing 10.

In the embodiment considered in the figures, the hot water inlet 14 and the cold water inlet 15 extend from the chamber 11 radially to the axis X-X. As for the mixed water outlet 16, same extends from the chamber 11 parallel to the axis X-X, being even here substantially centered on this axis. Furthermore, the upper housing 13 includes the lateral wall 17 of the chamber 11 and delimits both the hot water inlet 14 and the cold water inlet 15, while the lower housing 12 delimits the mixed water outlet 16.

The thermostatic cartridge 1 also includes a slide-valve 20, which is visible in FIGS. 1 and 2. The slide-valve 20 is mounted inside the chamber 11 in a manner movable along the axis X-X between two extreme positions, namely:
a lower extreme position, wherein a seat 20A of the slide-valve 20, which is located at a lower axial end of this slide-valve, is axially supported against a seat 10A of the casing 10, which is located, along the axis X-X, substantially at the level of the outlet of the hot water inlet 14 inside the chamber 11, and
an upper extreme position, wherein a seat 20B of the slide-valve 20, which is located at an upper axial end of the slide-valve 20, is supported against a seat 10B of the casing 10, which is located, along the axis X-X, substantially at the cold water inlet 15 inside the chamber 11.

In the embodiment considered in the figures, the seat 10A of the casing 10 is formed by the lower housing 12, more precisely by an upper end edge of the latter, while the seat 10B of the casing is formed by the upper housing 13, more precisely by an internal shoulder of the latter. As for the seats 20A and 20B of the slide-valve 20, they are formed by lower and upper end edges respectively, of the slide-valve 20.

In all cases, the axial dimension of the slide-valve 20, separating the opposite seats 20A and 20B thereof from each other, is less than the axial distance separating the seats 10A and 10B of the casing 10 from each other. Thus, the seat 20A of the slide-valve 20 and the seat 10A of the casing 10 delimit between them, along the axis X-X, a hot water passage P1 on which the hot water inlet 14 opens into the chamber 11. Similarly, the seat 20B of the slide-valve 20 and the seat 10B of the casing 10 delimit between them, along the axis X-X, a cold water passage P2 on which the cold water inlet 15 opens into the chamber 11.

It is understood that, when the slide-valve 20 is in the lower extreme position thereof, the slide-valve closes the hot water passage P1 and thus completely closes, except for leaks, the admission of hot water into the chamber 11, while opening the admission of cold water into this chamber to the maximum via the open cold water passage P2. Conversely, when the slide-valve 20 is in the upper extreme position thereof, the slide-valve closes the cold water passage P2 and thus completely closes, except for leaks, the admission of cold water into the chamber 11, while opening the admission of hot water into this chamber to the maximum via the hot water passage P1. Of course, depending on the position of the slide-valve 20 along the axis X-X between these upper and lower extreme positions, the respective blockages of the hot water passage P1 and the cold water passage P2 vary inversely, which means that the quantities of hot and cold water admitted into the chamber 11 are regulated, in respective inverse proportions, by the slide-valve 20 according to the axial position thereof. In FIGS. 1 and 2, the slide-valve 20 occupies the upper extreme position.

According to an advantageous arrangement, which is implemented in the embodiment considered here, the hot water passage P1 and the cold water passage P2 each run around the axis X-X, possibly over 360°. To this end, the seats 10A, 10B, 20A, and 20B each run all around the axis X-X. In this way, the distribution of hot and cold water in the hot water passages P1 and cold water passages P2 around the axis X-X is improved.

The slide-valve 20 is mounted inside the chamber 11 sealing the hot water inlet 14 and the cold water inlet 15 from each other outside the slide-valve. To this end, in the embodiment considered here, the slide-valve 20 is provided with a peripheral seal 21, which runs all around the outer lateral face of the slide-valve and is pressed, radially to the axis X-X, against the lateral wall 17 of the chamber 11, to form a seal for hot and cold water between the hot water inlet 14 and the cold water inlet 15. Moreover, for the cold water admitted into the chamber 11 via the cold water inlet 15 to be able to join and mix with the hot water admitted into the chamber via the hot water inlet 14, to form the mixed water flowing downstream of the slide-valve 20 to the mixed water outlet 16, the slide-valve 20 has flow orifices 22, which are indicated only in dotted lines in FIG. 2 and which connect the opposite axial faces of the slide-valve. It should be noted that the arrangements of the slide-valve 20, such as the seal 21, allowing the hot water inlet 14 and the cold water inlet 15 to be sealed from each other outside the slide-valve, as well as the arrangements of the slide-valve, such as the flow orifices 22, allowing the flow of cold water through the slide-valve to join the hot water, are not limiting.

To drive the slide-valve 20 in translation along the axis X-X, the cartridge 1 includes a thermostatic element 30, which is visible in all the figures, being shown alone in FIGS. 3 and 4. The thermostatic element 30 includes a body 31 and a piston 32, which, in the assembled state of the cartridge 1, are substantially centered on the axis X-X, the piston 32 being partially received in the body 31. The thermostatic element 30 is designed for the body 31 thereof and the piston 32 thereof to move relative to each other along the axis X-X, this relative movement being controlled by a temperature variation applied to the body 31 which, therefore, can be described as a thermosensitive body. To do this, the body 31 contains a thermodilatable material 33 which is schematically indicated only in FIG. 1: during the expansion thereof, the thermodilatable material 33 causes the piston 32 to move relative to the body 31 while, during the contraction thereof, the thermodilatable material 33 allows the piston to retract relative to the body.

To guide the relative movement along the axis X-X between the body 31 and the piston 32, the body 31 includes a guide 34 wherein the piston 32 is slidably mounted along the axis X-X, while axially emerging from this guide 34. The guide 34 thus forms an upper terminal part of the body 31. Moreover, here, the guide 34 has a tubular shape, which is centered on the axis X-X and the inner bore thereof receives the piston 32 in a complementary manner, except for a sliding clearance. In practice, the sliding mounting of the piston 32 in the guide 34 is advantageously made sliding by lubricants, not visible in the figures and placed at the interface between the piston 32 and the guide 34.

In the embodiment considered in the figures, the body 31 also includes a cup 35 which extends downward from the guide 34 and thus forms here a lower terminal part of the body 31. In practice, the guide 34 and the cup 35 are fixedly secured to each other, by any appropriate means. The cup 35 advantageously contains the thermodilatable material 33, being made of a thermally conductive material, typically metallic. In the assembled state of the cartridge 1, the cup 35 is arranged to be in contact with the mixed water contained in the chamber 11. More generally, whatever the embodiment of the body 31, the latter is arranged to be in contact with the mixed water within the cartridge 1, being at least partially disposed in the chamber 11 and, if applicable, in the mixed water outlet 16: in this way, the thermodilatable material 33 is thermally sensitized by the mixed water from the chamber 11, so that the relative axial movement between the body 11 and the piston 32 is controlled by the temperature of this mixed water.

In all cases, in the assembled state of the cartridge 1, the body 31 is connected to the slide-valve 20 to drive the slide-valve 20 in movement along the axis X-X inside the chamber 11, so that the slide-valve 20 blocks, in respective inverse proportions, the hot water passages P1 and cold water passages P2 as explained hereinabove. In the embodiment considered in the figures, the body 31 and the slide-valve 20 are fixedly secured to each other by screwing, here centered on the axis X-X: to this end, the guide 34 of the body 31 is externally provided with a thread 36, here centered on the axis X-X, while the slide-valve 20 is internally provided with a tapping 23, which is complementary to the thread 34 and which is coaxially disposed in a passage 24 of the slide-valve 20. The passage 24 axially traverses the slide-valve 20 from end to end, being centered on the axis X-X, and, in the assembled state of the cartridge 1, internally receives the guide 34 in a complementary manner. In practice, other embodiments, than screwing the thread 36 into the tapping 23, are conceivable to connect the body 31 and the slide-valve 20 in movement along the axis X-X, in particular by means of cooperation by shape complementarity between the guide 34 and the passage 24: e.g., the guide 34 is externally smooth and is received in a complementary manner in the internally smooth passage 24, being axially fixed in position relative to the body 31 by an added part such as a nut, a circlip, etc.

As for the piston 32, the latter is, in the assembled state of the cartridge 1, connected to the casing 10, here by a mechanism 40 acting on the axial position of the piston 32 relative to the casing 10, this mechanism 40 being detailed further.

In the hypothesis where the mechanism 40 keeps the position of the piston 32 fixed along the axis X-X relative to the casing 10, the temperature of the mixed water at the outlet of the cartridge 1 is thermostatically regulated by the slide-valve 20 and the thermostatic element 30. Indeed, in this hypothesis, the temperature of the mixed water directly results from the respective quantities of hot and cold water admitted into the chamber 11 via the hot water passage P1 and the cold water passage P2 respectively more or less blocked by the slide-valve 20, as explained hereinabove. If the supply of the cartridge with hot and/or cold water is disturbed and, e.g., the temperature of the mixed water increases, the piston 32 axially deploys relative to the body 31, which causes the downward translation of the body 31 and thus of the slide-valve 20: the proportion of hot water circulating in the hot water passage P1 decreases while, conversely, the proportion of cold water circulating in the cold water passage P2 increases, which leads to a decrease in the temperature of the mixed water. An inverse reaction occurs when the temperature of the mixed water decreases, it being noted that a compression spring 50 is provided to recall the body 31 and the piston 32 towards each other, which amounts to the piston 32 retracting into the body 31, during a contraction of the thermodilatable material 33. In the embodiment considered in the figures, this return spring 50 is axially interposed between, on the one hand, the casing 10, here the lower housing 12, and, on the other hand, the body 31, here with the interposition of a plate. The corrections of the temperature of the mixed water result in a regulation balance for this temperature of the mixed water, and this at a thermostatic regulation temperature that depends on the position, imposed by the mechanism 40, of the piston 32 along the axis X-X.

The mechanism 40 allows the value of the thermostatic regulation temperature to be adjusted and thus the temperature of the mixed water to be controlled, by acting on the axial position of the piston 32. In the embodiment considered here, the mechanism 40 is carried by the casing 10, here by the upper housing 13 and includes a stop 41, against which the upper end of the piston 32 is axially supported and which is slidably mounted, along the axis X-X, inside a nut 42, with axial interposition between the stop 41 and the nut 42 of an overtravel spring 43. The axial position of the nut 42 inside the casing 10 and, thereby, the height of the stop 41, are modifiable by an adjustment screw 44, which is centered on the axis X-X and whose upper end emerges from the upper housing 13 to be rotationally connected with a maneuvering handle, not shown in the figures. At the lower end thereof, the adjustment screw 44 is screwed into the nut 42, the latter being rotationally connected around the axis X-X to the upper housing 13, typically by splines. Thus, when the screw 44 is driven in rotation on itself around the axis X-X, the nut 42 translates along this axis, which causes the corresponding drive of the stop 41 by means of the overtravel spring 43, it being emphasized that this overtravel spring 43 is substantially stiffer than the return spring 50.

The structure and operation of the adjustment mechanism 40 will not be described further here, it being understood that the reader can refer to FR 2 869 087 for this purpose. It is recalled that the embodiment of this mechanism 40 is not limiting for the invention: other embodiments are known in the art, e.g. in FR 2 921 709, FR 2 774 740, and FR 2 870 611. Moreover, as a non-represented variant, if one renounces being able to adjust the value of the temperature at which the slide-valve 20 regulates the mixing of hot and cold water, the mechanism 40 can be removed from the thermostatic cartridge 1, the piston 32 then being fixedly connected to the casing 10.

Returning now to the description of the thermostatic element 30, it should be noted that the latter includes a sealing sleeve 37 which, as clearly visible in FIGS. 1 to 4, is coaxially fitted around both the guide 34 of the body 31 and the piston 32 of the thermostatic element 30, to seal the sliding mounting of the piston 32 in the guide 34. The sealing sleeve 37 thus prevents the mixed water contained in the chamber 11, as well as the particles potentially present in this mixed water, such as lime particles, from entering the thermostatic element 30 and reaching the sliding mounting of the piston 32 in the guide 34, at the risk of damaging this sliding mounting. The sealing sleeve 37 also prevents the aforementioned lubricants from escaping from the thermostatic element 30, by escaping from the sliding mounting of the piston 32 in the guide 34.

The sealing sleeve 37 has a generally tubular shape, which is substantially centered on the axis X-X and which runs continuously all around the axis X-X. As shown in FIG. 4, the sealing sleeve 37 thus includes three distinct tubular parts along the axis X-X, namely a lower part 37.1 and an upper part 37.2, which are opposed to each other along the axis X-X, as well as an intermediate part 37.3 which connects the lower part 37.1 and the upper part 37.2 to each other.

The lower part 37.1 is fixedly connected to the guide 34 along the axis X-X, by any appropriate means. In the embodiment considered in the figures, the guide 34 is externally provided with a peripheral groove 38 wherein the lower part 37.1 of the sealing sleeve 37 is embedded to fixedly connect this lower part 37.1 to the guide 34 along the axis X-X. Of course, other embodiments are conceivable as long as the sealing sleeve 37 is, by the lower part 37.1 thereof, fixedly connected to the guide 34 along the axis X-X.

The upper part 37.2 of the sealing sleeve 37 is applied against the piston 32 all around the axis X-X in sliding contact along this axis. In the embodiment considered in the figures, the upper part 37.2 of the sealing sleeve 37 forms a ring that is tightly adjusted all around the piston 32, being in particular tightly adjusted all around the piston 32, while allowing the relative axial sliding between this ring and the piston 32. Of course, other embodiments are conceivable as long as the sealing sleeve 37 is, by the upper part 37.2 thereof, applied in contact, both sealed and sliding along the axis X-X, with the piston 32 all around the axis X-X. During the movement of the piston 32 relative to the body 31, and this in both possible opposite directions, the piston 32 slides against the upper part 37.2, without modifying either the axial position of this upper part 37.2 relative to the casing 10, or modifying the total axial dimension of the sealing sleeve 37.

According to a particularly advantageous arrangement that improves the sealing performance at the upper part 37.2 of the sealing sleeve 37, this upper part 37.2 is applied against the piston 32 in a substantially radial manner to the axis X-X by the elastic resilience effect of the sealing sleeve 37, particularly of the intermediate part 37.3 thereof. To this end, the sealing sleeve 37 has an elasticity that tends to make the sealing sleeve return to the rest shape thereof, so that by subjecting the upper part 37.2 to a radial stress oriented opposite to the axis X-X due to the presence of the piston 32 arranged coaxially through the upper part 37.2, the sealing sleeve 37, particularly the intermediate part 37.3 thereof, generates by elasticity, an opposite radial stress that presses the upper part 37.2 against the piston 32. To this end, the sealing sleeve 37 is e.g. made of an elastomeric material, such as rubber or EPDM.

According to another particularly advantageous arrangement, which can be combined with the above, the piston 32 is externally smooth over at least the entire upper part thereof that emerges from the guide 34 when the piston 32 is deployed to the maximum vis-à-vis the body 31. In practice, it is possible to make provision that the piston is externally smooth over the entire axial dimension of this piston. The piston 32 then has the advantage of being inexpensive and easy to assemble with the rest of the thermostatic element 30.

Without impairing the sealing performance thereof vis-à-vis the sliding mounting of the piston 32 in the guide 34, the sealing sleeve 37 is advantageously dimensioned compactly, both transversely to the axis X-X and along this axis X-X.

Thus, regarding the transverse dimensioning to the axis X-X of the sealing sleeve 37, the maximum outer diameter of the sealing sleeve 37, noted D 37 in FIG. 2, is advantageously less than the minimum inner diameter of the passage 24, noted D 24. In the embodiment considered in the figures, this implies that the maximum outer diameter D37 of the sealing sleeve 37 is less than the diameter of the top of the tapping 23 of the passage 24. In this way, the introduction of the guide 34 into the passage 24 during the assembly of the cartridge 1 is feasible while leaving the sealing sleeve 37 in place on the guide 34 and the piston 32. In particular, it is then not necessary to partially or totally remove the sealing sleeve 37, possibly also removing the piston 32, to assemble the slide-valve 20 and the thermostatic element 30 to each other.

Regarding the axial dimensioning of the sealing sleeve 37, the total axial dimension of the sealing sleeve 37 is advantageously limited as much as possible, in particular to prevent the sealing sleeve 37 from occupying substantial space in the chamber 11, which would hinder the flow of water and limit the maximum admissible flow rate by the cartridge 1. To this end, according to a first advantageous dimensional aspect, the upper part 37.2 of the sealing sleeve 37 is axially juxtaposed to the guide 34, as clearly visible in FIG. 4: in other words, the upper part 37.2 of the sealing sleeve caps the upper end of the guide 34, directly covering the upper end edge of the guide 34, except for an axial clearance. According to a second advantageous dimensional aspect, the maximum axial dimension of the sealing sleeve 37, noted L 37 in FIG. 4, is less than the maximum outer diameter, noted D 34, of the region of the guide 34, by which the lower part 37.1 of the sealing sleeve 37 is fastened to the guide 34 along the axis.

In continuation of the above considerations regarding the axial compactness of the sealing sleeve 37, an additional advantageous aspect concerns the piston 32, in the sense that, somewhat similarly to the sealing sleeve 37, the upper terminal part of the piston 32 can be dimensioned axially in a reduced manner. It is then the thermostatic element 30, considered as a whole, that proves to be particularly compact along the axis X-X. To this end, provision is advantageously made that, when the piston 32 is retracted to the maximum in the body 31, the piston 32 axially emerges from the sealing sleeve 37 over a non-zero axial extent, noted e32 in FIG. 3, which is less than or equal to one millimeter. In this way, the risk of jamming of the piston 32 in the guide 34 is significantly reduced.

Finally, various arrangements and variants to the thermostatic cartridge 1 described so far are also conceivable. As examples:
other materials than those mentioned above are conceivable for the sealing sleeve 37, e.g. silicone; and/or
rather than the casing 10, the slide-valve 20, the thermostatic element 30, and the return spring 50, as well as, if applicable, the mechanism 40 may be assembled to each other in the form of a thermostatic cartridge capable of being fitted as a single unit into a faucet body, such as the thermostatic cartridge 1 considered so far, the slide-valve 20 and the thermostatic element 30, as well as, if applicable, the mechanism 40 and the return spring 50, being installed directly in a faucet body, the latter then forming a casing functionally similar to the casing 10.

What is claimed is:

1. A thermostatic assembly, including:
a casing wherein are defined:
a chamber, which defines an axis and wherein a hot fluid and a cold fluid mix to form a mixed fluid,
a hot fluid inlet through which the hot fluid enters the chamber from outside the casing,
a cold fluid inlet through which the cold fluid enters the chamber from outside the casing, and
a mixed fluid outlet through which the mixed fluid contained in the chamber exits the casing,
a slide-valve for regulating the temperature of the mixed fluid, the slide-valve being movable along the axis inside the chamber to block, in respective inverse proportions, a hot fluid passage and a cold fluid passage each axially delimited between the slide-valve and the casing, the hot fluid passage being supplied by the hot fluid from the hot fluid inlet while the cold fluid passage is supplied by the cold fluid from the cold fluid inlet, and
a thermostatic element which comprises:
a body, which contains a thermodilatable material and is at least partially arranged in the chamber to be in contact with the mixed fluid and to be connected to the slide-valve to drive the slide-valve in movement along the axis inside the chamber,
a piston, which is connected to the casing being centered on the axis and is partially received in the body in a manner movable along the axis under the action of the thermodilatable material during an expansion of the thermodilatable material, the piston being slidably mounted along the axis in a guide of the body, from which the piston emerges outside the body, and
a sealing sleeve, which is coaxially fitted around the guide and the piston to seal the sliding mounting of the piston in the guide, which sealing sleeve including a first part, which is fixedly connected to the guide along the axis, and a second part which is applied against the piston all around the axis in sliding contact along the axis.

2. The thermostatic assembly according to claim 1,
wherein the slide-valve is provided with a passage, which axially traverses the slide-valve from end to end, being centered on the axis, and which receives the guide in a complementary manner,
and wherein the maximum outer diameter of the sealing sleeve is less than the minimum inner diameter of the passage.

3. The thermostatic assembly according to claim 2, wherein the guide and the passage cooperate by shape complementarity to connect the body and the slide-valve in movement along the axis.

4. The thermostatic assembly according to claim 2, wherein the body and the slide-valve are fixedly secured to each other by screwing a thread of the guide into a tapping of the passage.

5. The thermostatic assembly according to claim 1, wherein the second part of the sealing sleeve is axially juxtaposed to the guide.

6. The thermostatic assembly according to claim 1, wherein the maximum axial dimension of the sealing sleeve is less than the maximum outer diameter of the region of the guide, by which the first part of the sealing sleeve is fixed along the axis to the guide.

7. The thermostatic assembly according to claim 1, wherein, when the piston is retracted to the maximum in the body, the piston axially emerges from the sealing sleeve over an axial extent that is less than or equal to one millimeter.

8. The thermostatic assembly according to claim 1, wherein the second part of the sealing sleeve is applied against the piston in a substantially radial manner to the axis by the elastic resilience effect of the sealing membrane.

9. The thermostatic assembly according to claim 1, wherein the piston is externally smooth over at least the entire part thereof that emerges from the guide when the piston is deployed to the maximum vis-à-vis the body.

10. The thermostatic assembly according to claim 1, wherein the thermostatic assembly further includes a mechanism for controlling the temperature of the mixed fluid, this mechanism being carried by the casing and connecting the piston to the casing to adjust the position of the piston along the axis.

11. The thermostatic assembly according to claim 1, wherein the thermostatic assembly forms a thermostatic cartridge adapted to be fitted as a single unit into a faucet body.
